(19) United States
(12) Patent Application Publication
(10) Pub. No.: US 2026/0062051 A1
(43) Pub. Date: Mar. 5, 2026

(54) STEERING SYSTEMS AND RELATED METHODS

(71) Applicant: Ford Global Technologies, LLC, Dearborn, MI (US)

(72) Inventors: Mark Stephen Eubank, Monroe, MI (US); Johnathan Lupulescu, Rochester Hills, MI (US); Matthew Malenfant, Livonia, MI (US); Juliana Nogueira Vilela, Livonia, MI (US); Eric Schaus, Morgantown, PA (US); Jaxon Wilkerson, Mooresville, NC (US)

(21) Appl. No.: 18/821,537

(22) Filed: Aug. 30, 2024

(51) Int. Cl. B62D 7/16; B62D 5/04; B62D 5/20; B62D 6/00; B62D 7/20

(52) U.S. Cl. CPC B62D 7/163; B62D 5/0421; B62D 5/20; B62D 6/002; B62D 7/20

(57) ABSTRACT

Steering systems and related methods are disclosed. An example apparatus includes a vehicle frame and a steering linkage assembly including a drag link having a first end and a second end opposite the first end. The apparatus further including at least one of: a hydraulic power assist system to couple to the vehicle frame, the hydraulic power assist system to couple to the first end of the drag link via a first pitman arm; or an electric power assist system to couple to the vehicle frame, the electric power assist system to couple to the first end of the drag link via a second pitman arm, the first pitman arm different than the second pitman arm to enable the first pitman arm and the second pitman to have a common pitman to hardpoint connection with the drag link of the steering linkage assembly.

### FIELD OF THE DISCLOSURE

This disclosure relates generally to vehicles and, more particularly, to steering systems and related methods.

### BACKGROUND

Vehicles include multiple subsystems to perform various functions. A steering subsystem enables a vehicle operator to control the direction of movement of the vehicle. Additionally, power steering enables drivers to turn a steering wheel more easily and, in turn, road wheels when maneuvering a vehicle. For example, hydraulic and/or electric actuators add controlled energy to a steering gear when a driver turns a steering wheel to reduce a physical effort necessary to turn the road wheels.

### BRIEF DESCRIPTION OF THE DRAWINGS

FIG. 1 is a perspective view of an example vehicle in which examples disclosed herein can be implemented.

FIG. 2 is a schematic of an example steering system of the example vehicle of FIG. 1 including example steering control circuitry.

FIG. 3 is a bottom view of an example steering linkage assembly of the example steering system of FIG. 2.

FIG. 4A is a bottom view of the example steering linkage assembly of FIG. 3 including an example first power assist system.

FIG. 4B is a perspective view of the example first power assist system of FIG. 4A.

FIG. 4C is a front view of an example first pitman arm disclosed herein.

FIG. 5A is a bottom view of the example steering linkage assembly of FIG. 3 including an example second power assist system.

FIG. 5B is a perspective view of the example second power assist system of FIG. 5A.

FIG. 5C is a front view of an example second pitman arm disclosed herein.

FIG. 6 is a schematic illustration of an example process control of the example steering system of FIG. 2.

FIG. 7 is a block diagram of an example implementation of the steering control circuitry of FIG. 2.

FIG. 8 is a flowchart representative of example machine readable instructions and/or example operations that may be executed, instantiated, and/or performed by example programmable circuitry to implement the example steering control circuitry of FIG. 7.

FIG. 9 is a block diagram of an example processing platform including programmable circuitry structured to execute, instantiate, and/or perform the example machine readable instructions and/or perform the example operations of FIG. 8 to implement the example steering control circuitry of FIG. 7.

FIGS. 10, 11A-11B and 12 are views of other example vehicles having other example steering assemblies in which examples disclosed herein can be implemented.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Vehicles include power steering assist systems to reduce an amount of driver applied torque required to turn the wheels of the vehicle. Power assist steering systems include hydraulic power assist steering (HPAS) systems, which use engine-pressurized hydraulic fluid to apply steering assistance force to the steering system and electric power assist steering (EPAS) systems, which use an electric motor to directly apply torque to the steering system.

Vehicles, such as heavier vehicles, heavy trucks, pick-up trucks, and sport utility vehicles (SUVs), can employ either hydraulically assisted or electrically assisted steering systems. However, a position of a steering gear associated with the power assist steering system in relation to a frame of a vehicle is different between hydraulic steering gear and electric steering gear due to different envelopes of HPAS systems and EPAS systems. For example, a steering gear package having an electrically assisted gear typically has a larger package envelop than a steering gear package having a hydraulically assisted gear. As a result, HPAS systems and EPAS systems have different linkage-to-pitman hardpoint connection positions (e.g., in a y-direction or across a width of a vehicle). As a result, hydraulically assisted and electrically assisted steering gears cannot be interchanged with the same vehicle or vehicle platform (e.g., a heavy duty truck) because employing the HPAS or the EPAS systems requires different steering ratios between the two systems and, thus, different steering linkage assemblies.

Thus, due to the different linkage-to-pitman hardpoint connections between HPAS and EPAS systems, each system requires a dedicated steering linkage assembly (e.g., drag links, tie rods, pitman arms, steerable axle, center links, idler arms, etc.) to achieve symmetric steering ratios. However, having dedicated steering assemblies for each of the HPAS and EPAS systems results in increased linkage complexity at the assembly plant and/or increased part count.

Employing a common steering linkage assembly between an HPAS system and an EPAS system results in an asymmetric number of steering wheel revolutions between straight ahead and full lock left and full lock right due to the different linkage-to-pitman hardpoint connection positions. In other words, for example, the steering wheel can be turned to the left a greater amount (e.g., 720 degrees) compared to the right (e.g., 680 degrees) to achieve a left lock-to-right lock rotation. These example left and right steering wheel inputs achieve the same magnitude of vehicle motion (e.g. steering angles) in opposite directions (e.g., even though the steering wheel inputs used to achieve the same magnitude of vehicle motion are different). Such asymmetric steering relationships between left turns and right turns can pose challenges with the operation of advanced driver assist technologies (e.g., driver assist steering, trailer backup assist, etc.).

Examples disclosed herein enable interchangeability between either an EPAS system or an HPAS system with a common vehicle platform using a common steering linkage assembly. For example, using the examples disclosed herein, a drag link or center link can be common between EPAS and HPAS systems. As a result, the steering linkage complexity is the same for hydraulic based and electric based steering systems, thereby facilitating or reducing manufacturing complexities. To accommodate for steering ratio differences between electrically assisted gear systems and hydraulically assisted gear systems when using a common steering linkage assembly, examples disclosed herein employ a steering compensation module to compensate for asymmetric steering. Specifically, when using advanced driver assistant systems, controller circuitry can be split or separated between left hand turns and right hand turns to compensate for asymmetric steering between left and right hand turns.

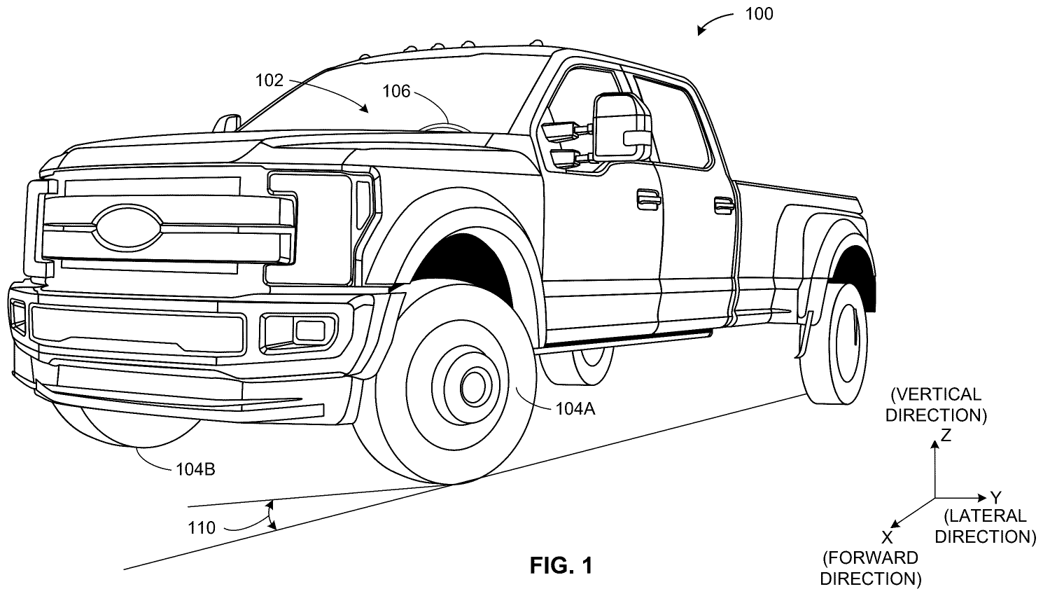

FIG. 1 illustrates an example vehicle 100 in which the teachings of this disclosure can be implemented. In the illustrated example of FIG. 1, the vehicle 100 is a pick-up truck. In other examples, the vehicle 100 can be any type of vehicle (e.g., a van, a coupe, a sedan, an SUV, a semi-trailer truck, a mini-van, a railed vehicle, an all-terrain vehicle (ATV), watercraft, construction equipment, farming equipment, etc.). In the illustrated example of FIG. 1, the vehicle 100 is a two-axle vehicle. In other examples, the vehicle 100 can have additional axles and/or additional wheels. The vehicle 100 can have a body-on-frame construction and/or a unibody construction.

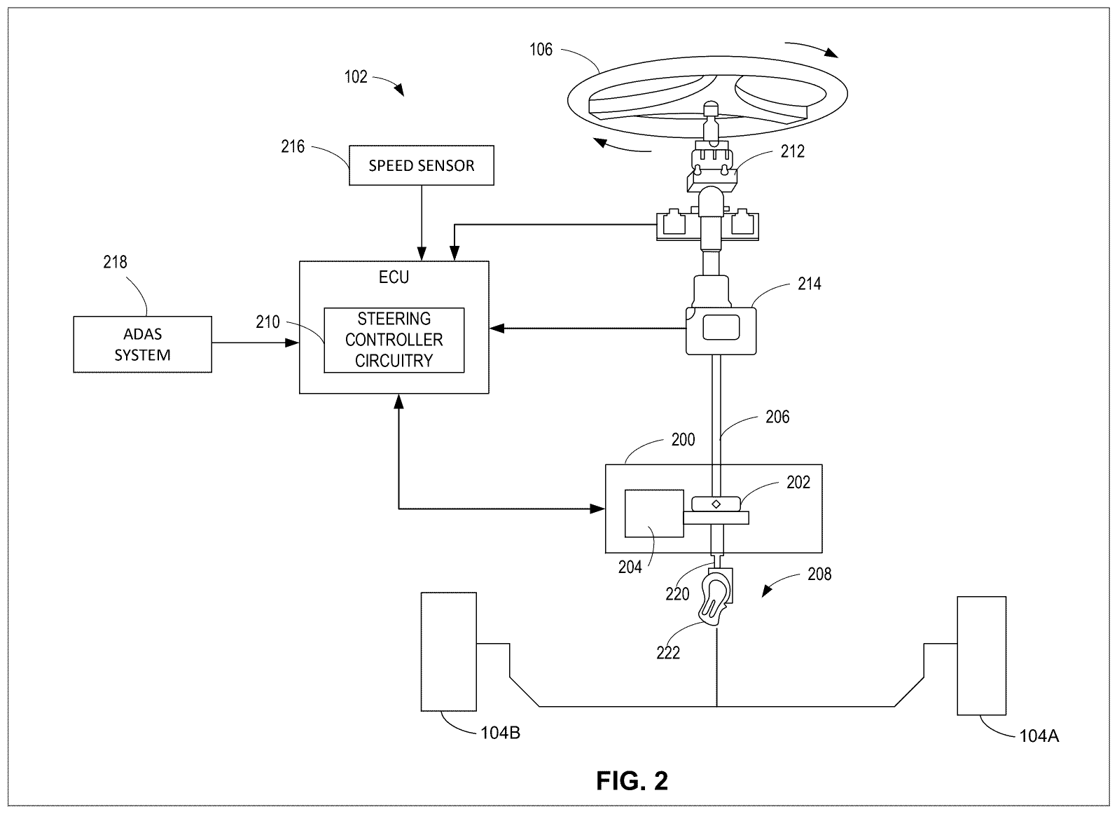

In the illustrated example of FIG. 1, the vehicle 100 includes an example steering system 102, an example first wheel 104A, and an example second wheel 104B. The steering system 102 includes an example steering wheel 106 to transmit driver inputs to the steering system 102 (e.g., by rotating the steering wheel, etc.). The steering system 102 receives these user inputs via the steering wheel 106, transforms the inputs into lateral forces (e.g., in the y-direction), and rotates the wheels 104A, 104B to change a steering angle 110 (e.g., a road wheel angle (RWA)) and a travel direction of the vehicle 100 (in the x-direction)). The steering system 102 is described in additional detail below in conjunction with FIG. 2. While the steering system 102 is used to control a front axle of the vehicle 100, examples disclosed herein are also applicable to steering systems associated with rear-steered axles.

Examples disclosed herein are suitable for driven and/or non-driven axles, front axles, rear axles, dependent and/or independent suspension architecture (e.g., twin I-beam front suspension). Examples disclosed herein can be used with heavy trucks, light trucks, pick-up trucks, SUVs, and other light vehicles. Examples disclosed herein have reduced vehicle packaging space requirements and reduced vehicle weight, which increase vehicle fuel efficiency and payload capabilities.

FIG. 2 is a schematic diagram of the steering system 102 of the vehicle 100 of FIG. 1 implemented in accordance with the teachings of this disclosure. The steering system 102 includes an example steering gearbox 200 including a steering gear 202 and an example power assist steering (PAS) system 204, an example steering column 206, an example steering linkage assembly 208, and example steering controller circuitry 210.

The steering column 206 (e.g., a steering shaft and an intermediate shaft) transfers steering inputs from the steering wheel 106 to the steering gear 202. In some examples, the steering column 206 includes a universal joint (U-joint). In other examples, the steering column 206 includes a plurality of steering columns and/or shafts that can be coupled together via any suitable means. The steering linkage assembly 208 is a plurality of mechanical parts (e.g., tie rods, pitman arms, drag links, center links, etc.) that operatively couple the steering gear 202 to the wheels 104A, 104B. In some examples, some or all of the shafts of the steering system 102 can be absent. In some such examples, the steering system 102 can be a steer-by-wire system.

The steering column 206 includes a steering wheel angle sensor (SWA) 212 and a steering wheel torque sensor 214 that output signals in response to rotational movement of and/or torque applied to the steering wheel 106 and/or the steering column 206. The SWA sensor 212 measures an angular or rotational position of the steering wheel 106 (e.g., relative to a reference (e.g., a zero degree position)) and the steering wheel torque sensor 214 can measure a rate of rotation of the steering wheel 106 and/or the steering column 206.

The steering gear 202 can transform input motion (e.g., caused by the rotation of the steering wheel 106, a command from the steering controller circuitry 210, a command from an example advanced driver assistance system (ADAS) 218, etc.) into a lateral or fore/aft force applied to the steering linkage assembly 208 coupled thereto. A lateral force output by the steering gear 202 changes the steering angle 110 of the wheels 104A, 104B of the vehicle 100 via the steering linkage assembly 208, which controls a direction of travel of the vehicle 100 (e.g., the steering angle 110 of FIG. 1). For example, an output 220 (e.g., a pinion gear or output shaft) of the steering gearbox 200 couples to the steering linkage assembly 208 via a pitman arm 222.

The steering gear 202 of the illustrated example includes the PAS system 204 to assist with rotation of the steering gear 202. The steering gear 202 and the PAS system 204 can be a unitary structure. For example, the steering gear 202 and the PAS system 204 can be an HPAS system, an EPAS system, a hydro-electric power assist steering system, and/or any other power assist steering system. The steering linkage assembly 208 of the illustrated example is common (e.g., the same) for all types of power assist systems employed with the steering system 102. Thus, an EPAS system can be interchanged with an HPAS system without requiring changes to components of the steering linkage assembly 208.

In the illustrated example of FIG. 2, the steering controller circuitry 210 receives sensor information from the example SWA sensor 212, the example steering wheel torque sensor 214, an example vehicle speed sensor 216, and/or the ADAS 218. The steering controller circuitry 210 commands the PAS system 204 to facilitate and/or cause rotation of the steering gear 202 in response to the received inputs (e.g., that may be caused by a driver turning the steering wheel 106). For example, the steering controller circuitry 210 determines a steering assist force to apply to the steering gear 202 via the PAS system 204. In some examples, the steering controller circuitry 210 can determine a steering assist force to apply to the steering gear 202 based on one or more inputs from the SWA sensor 212, the steering wheel torque sensor 214, and/or the vehicle speed sensor 216. In some examples, the steering controller circuitry 210 can determine a steering assist force based on a user input and/or a user preference.

In some examples, when the vehicle 100 is in a self-driving or hands-free driving mode, the steering controller circuitry 210 operates to control the PAS system 204 to adjust the steering of the vehicle 100 along a path (e.g., a target path, a path follower angle request, etc.). For example, the steering controller circuitry 210 receives inputs from the ADAS 218 of the vehicle 100 providing a target travel path of the vehicle 100.

The ADAS 218 of the illustrated example automates certain aspects of driving and/or improves driver situational awareness to increase safety. For example, the ADAS 218 (e.g., can include path follower circuitry that) determines and/or executes machine-readable instructions (e.g., a path follower angle request and/or any other self-driving command) to steer the vehicle 100 along a target or desired path. In FIG. 2, the ADAS 218 is shown as separate from the steering controller circuitry 210. For example, the ADAS 218 may be implemented by another controller of the electronic control unit. However, the ADAS 218 may be part of the steering controller circuitry 210. When the driver of the vehicle 100 does not interact with the steering wheel 106 (e.g., applies zero input torque) during the self-driving mode and/or other hands-free driving event(s), the ADAS 218 controls the steering angle 110 of the vehicle 100 (e.g., via a path follower angle request). In some examples, the ADAS 218 determines a path follower angle request based on a target path of the vehicle 100, a velocity of the vehicle 100, a current steering angle of the steering wheel 106, and/or a projected path of the vehicle 100. For example, the ADAS 218 employs sensors (e.g., Lidar sensors), radar, cameras, and/or other sensors to assess an environment of a vehicle, a desired vehicle travel path, a vehicle speed, and/or any other vehicle condition(s). Some example features of the ADAS 218 include, but are not limited to, driver assistance technologies, autonomous driving, power steering, lane assist, active steering, blind spot information, adaptive cruise control, hands-free assistance, trailer backup assistance, etc. The ADAS 218 can determine a vehicle travel path and/or desired vehicle wheel angles for a desired travel path and can input control signals to the steering controller circuitry 210 to move a rotational position of the steering gearbox 200 based on the control inputs from the ADAS 218. Thus, in examples involving hands-free and/or self-driving requests, the steering gearbox 200 (e.g., the PAS system 204 and the steering gear 202) receives inputs from the steering controller circuitry 210 and/or the ADAS 218 without input from the steering wheel 106. In some examples, the steering controller circuitry 210 is implemented in an electronic control unit (ECU) of the vehicle 100. Additionally or alternatively, the steering controller circuitry 210 can be implemented in another control system, control unit, and/or computing system of the vehicle 100.

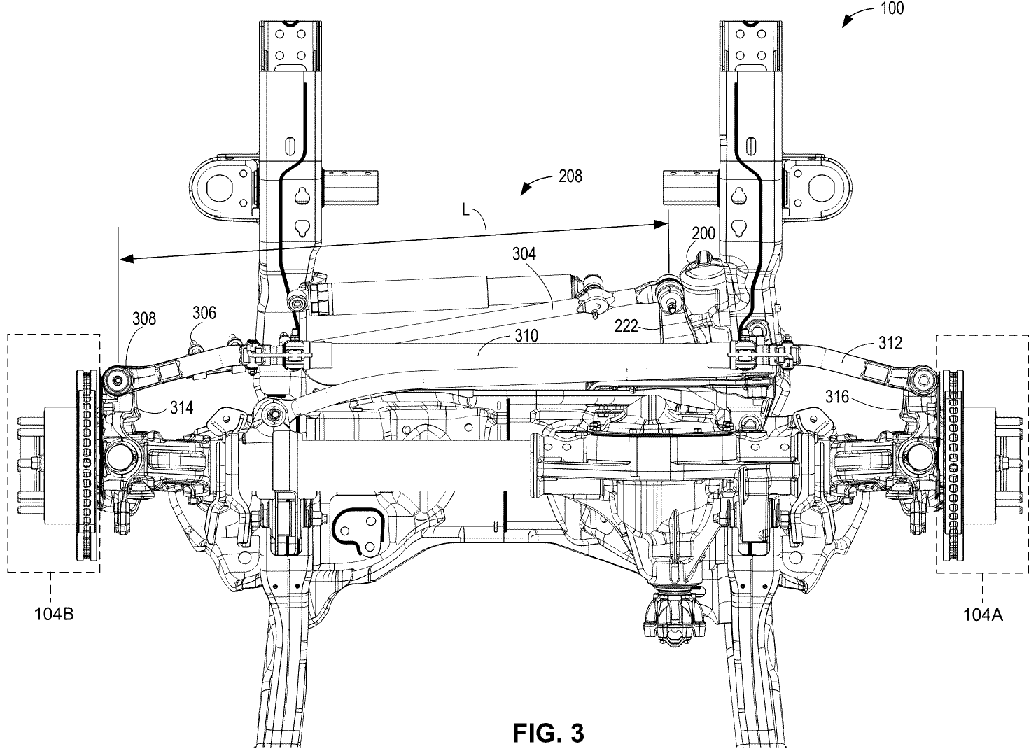

FIG. 3 is bottom view of the steering linkage assembly 208 of FIG. 2. In the illustrated example, the steering gear 202 of the steering gearbox 200 couples to the steering linkage assembly 208 via the pitman arm 222. Thus, the rotational output of the steering gear 202 causes rotational output of the pitman arm 222, which causes the steering linkage assembly 208 to move laterally to change a steering angle (e.g., the steering angle 110 of FIG. 1) of the wheels 104A, 104B. To change the steering angle 110 of the wheels 104A, 104B, the steering linkage assembly 208 of the illustrated example includes a plurality of mechanical components that operatively couple the pitman arm 222 and the wheels 104A, 104B. Specifically, the steering linkage assembly 208 of the illustrated example includes a drag link 304, an adjustment sleeve 306, a drag link end 308 (e.g., a first tie rod), a tie rod 310 (e.g., a steering tie rod) and a tie rod end 312 (e.g., a second tie rod). The drag link 304 of the illustrated example includes a first end that couples to the pitman arm 222 to provide a hardpoint connection with the pitman arm 222, and a second end coupled to the drag link end 308 via the adjustment sleeve 306. The tie rod 310 couples the drag link 304 and the tie rod end 312. Additionally, the drag link end 308 is coupled to a first steering knuckle 314 that rotates a steering angle of the second wheel 104B. The tie rod end 312 couples to a second steering knuckle 316 that rotates a steering angle of the first wheel 104A. Thus, in response to rotational output of the steering gear 202, the pitman arm 222 rotates, causing the drag link 304 to move laterally, which causes rotation of the first and second steering knuckles 314, 316 via the steering linkage assembly 208. The drag link 304, the adjustment sleeve 306 and the drag link end 308 have an overall a length L.

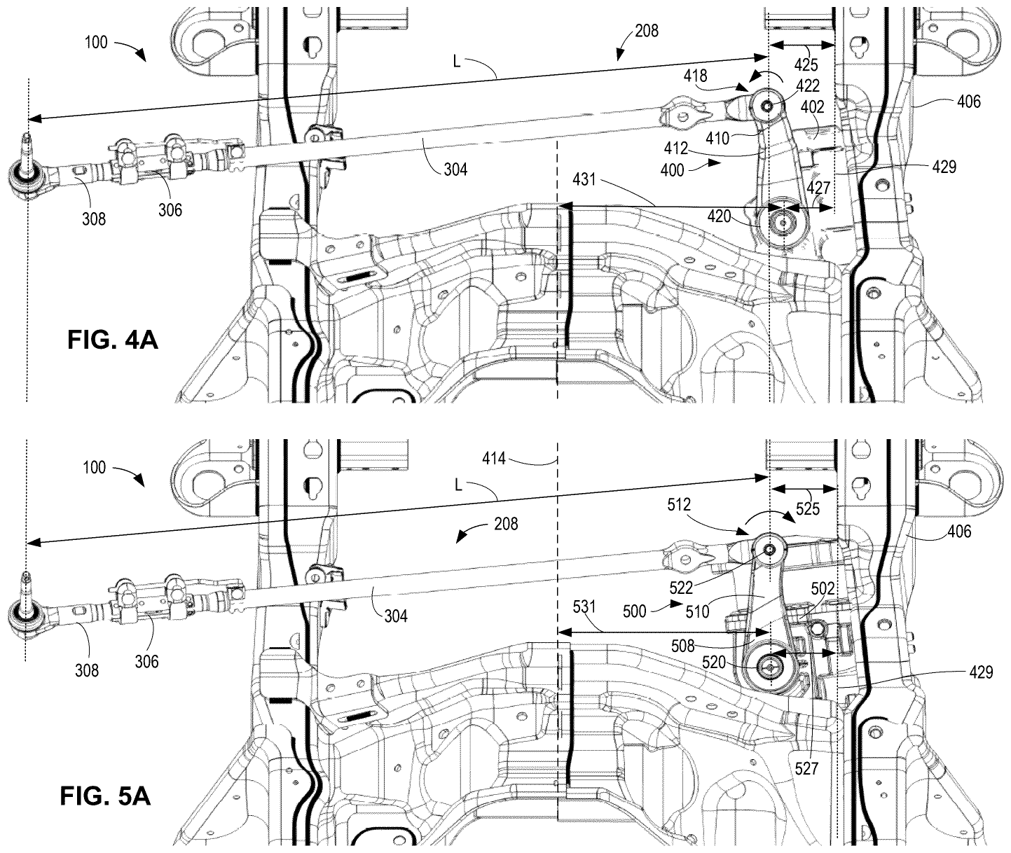

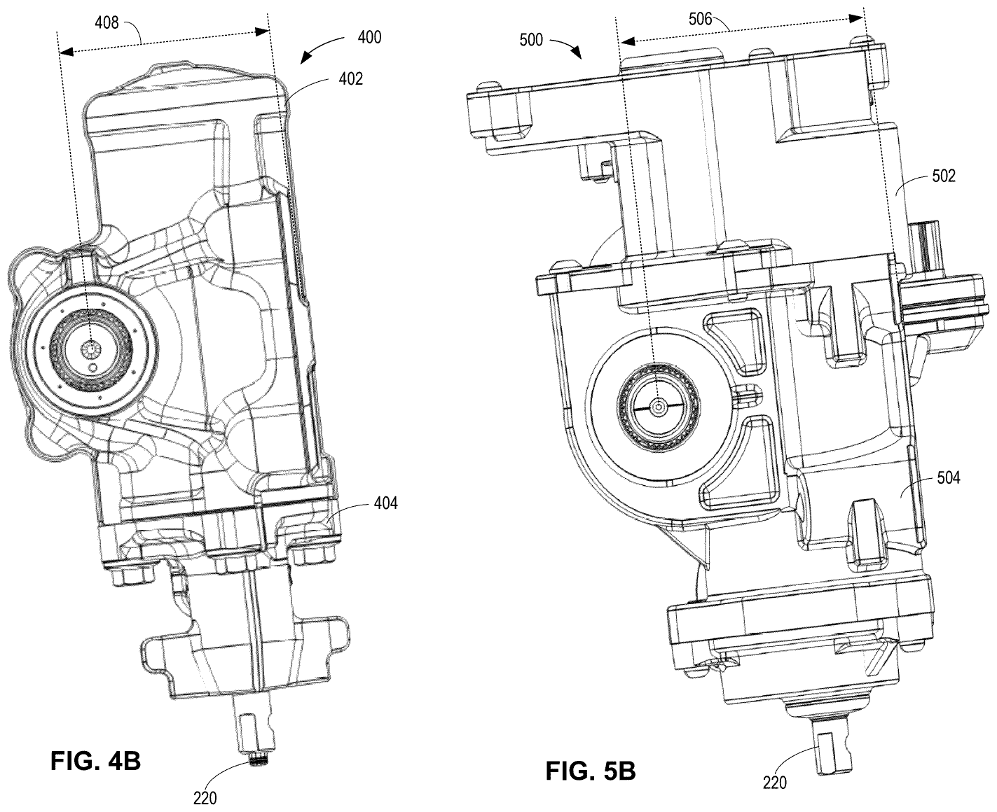

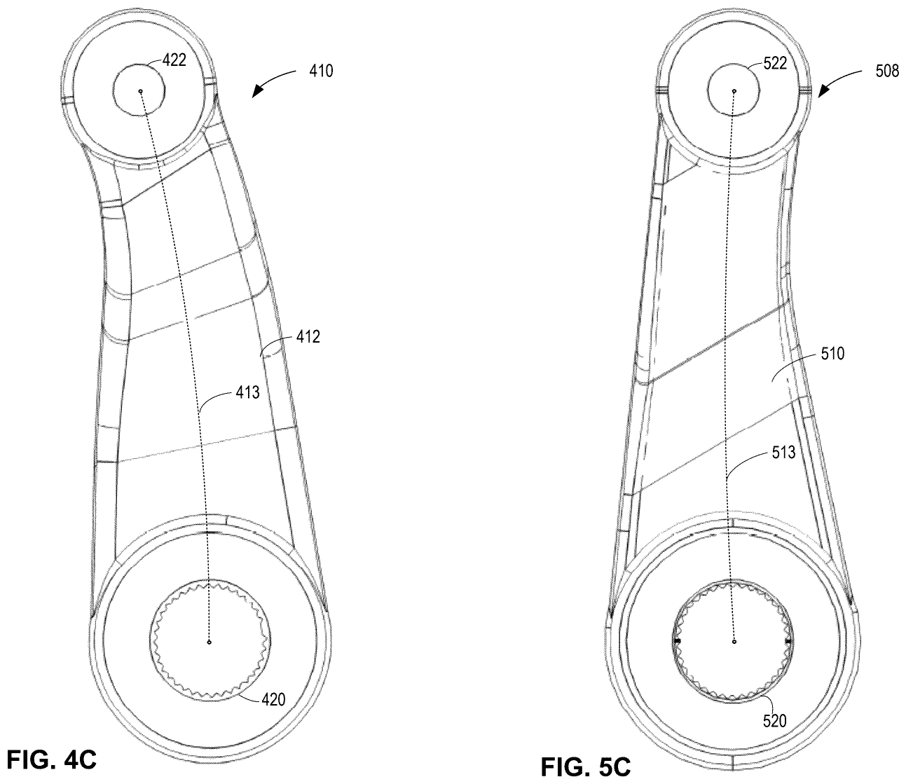

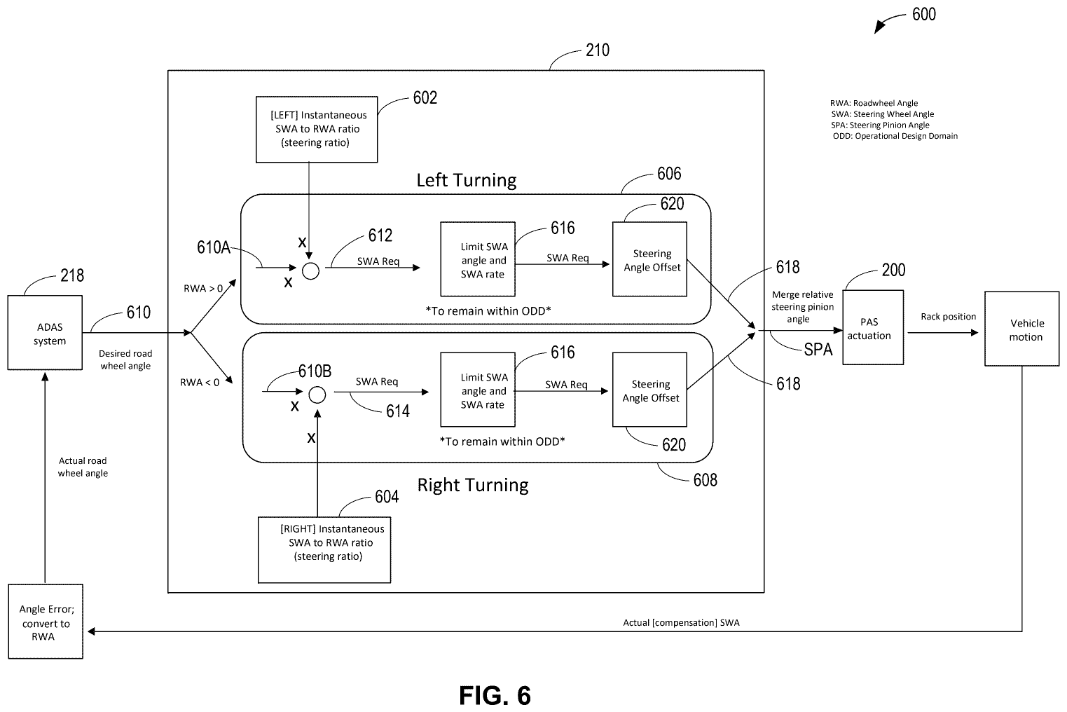

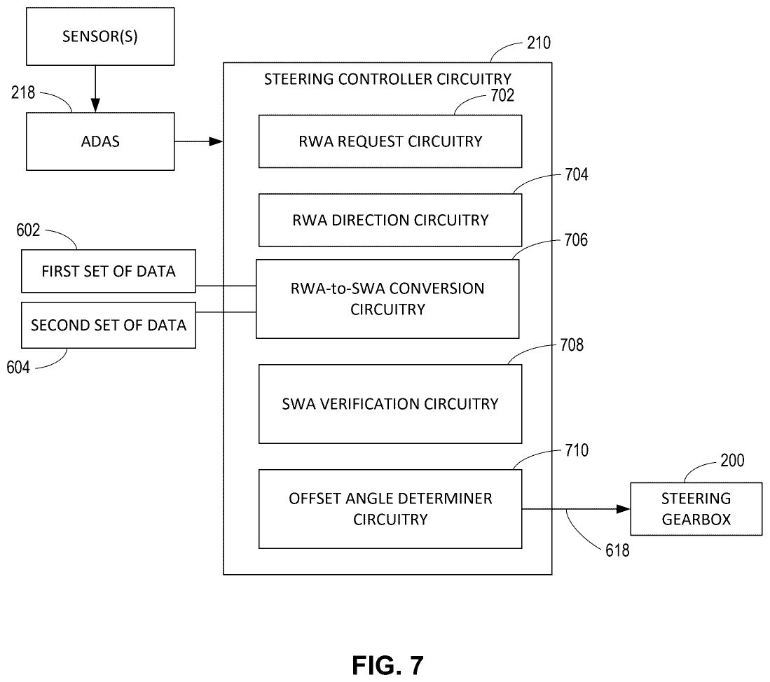

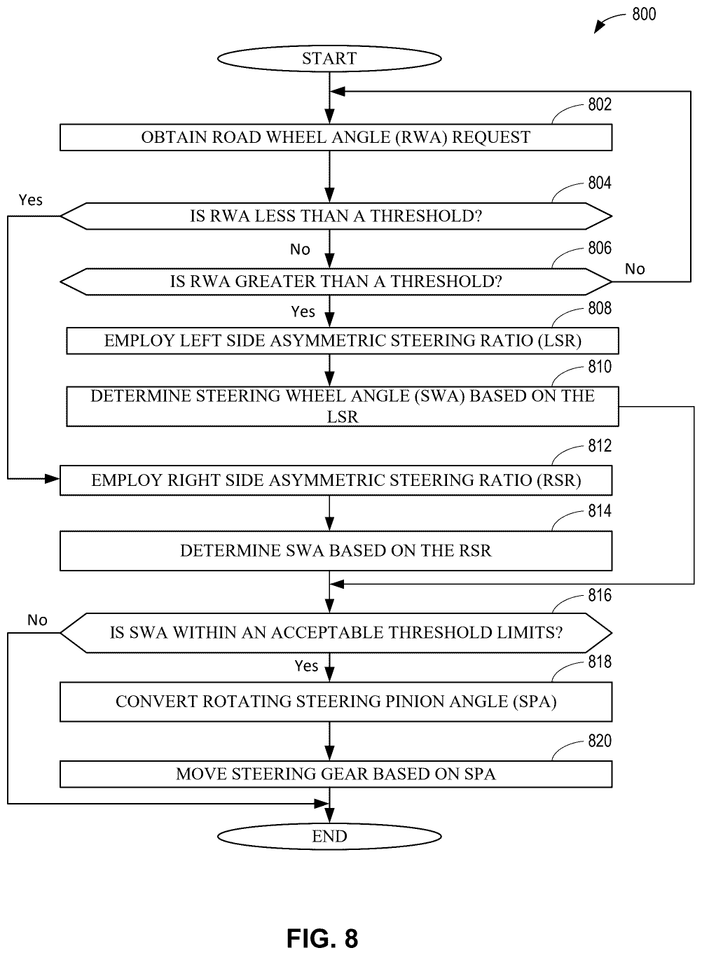

FIG. 4A is a bottom view of the vehicle 100 of FIG. 1 showing the steering gearbox 200 implemented as an example first steering gearbox system 400. FIG. 4B is a perspective side view of the example first steering gearbox system 400. FIG. 4C is a front view of an example first pitman arm 410 disclosed herein. Referring to FIGS. 4A-4C, the first steering gearbox system 400 of the illustrated example is an HPAS system 402. The HPAS system 402 of the illustrated example has a housing 404 that couples to a vehicle frame 406 of the vehicle 100. The housing 404 has a first housing envelope 408 (e.g., a width in a generally lateral or y-direction). Thus, a first hardpoint connection 418 between the first pitman arm 410 and the drag link 304 is affected or determined by the first housing envelope 408 of the HPAS system 402. The HPAS system 402 of the illustrated example is coupled to the drag link 304 of the steering linkage assembly 208 via the first pitman arm 410. The first pitman arm 410 of the illustrated example has an angled body 412. To accommodate the first housing envelope 408 and provide the first hardpoint connection 418 based on the length L of the drag link 304, the adjustment sleeve 306 and the drag link end 308, the angled body 412 of the first pitman arm 410 is offset inboard (e.g., angled toward a center or longitudinal axis 414 of the vehicle 100). For example, when coupled to the frame 406, the angled body 412 of the first pitman arm 410 is curved or angled toward the longitudinal axis 414 of the frame 406. Referring to FIGS. 4A and 4C, the first pitman arm 410 includes a first opening 420 to couple to the HPAS system 402 (e.g., the output gear 220) and a second opening 422 opposite the first opening 420 to couple to the drag link 304. For example, referring to FIG. 4C, a longitudinal axis 413 of the angled body 412 is curved or angled between the first opening 420 and the second opening 422. Referring to FIG. 4A, the angled body 412 causes the second opening 422 to be offset laterally (e.g., in the y-direction) relative to the first opening 420 when the first pitman arm 410 is coupled to the vehicle 100. For example, the first hardpoint connection 418 is offset by a first distance 425 from a reference 429 of the frame 406 (e.g., a right side of the frame 406). Additionally, the first opening 420 is offset relative to the frame 406 by a second distance 427 relative to the reference 429 of the frame 406. In this example, the second distance 427 is less than the first distance 425 when the linkage assembly 208 is positioned (as depicted in FIGS. 4A and 5A) so that the wheels 104A, 104B are in a straight ahead orientation. Thus, the second opening 422 of the first pitman arm 410 is closer to the longitudinal axis 414 of the frame 406 (e.g., in the y-direction) compared to a position or location of the first opening 420.

FIG. 5A is a bottom view of the vehicle 100 of FIG. 1 showing the steering gearbox 200 implemented as an example second steering gearbox system 500. FIG. 5B is a perspective side view of the second steering gearbox system 500. FIG. 5C is a front view of an example second pitman 508 disclosed herein. Referring to FIGS. 5A-5C, the second steering gearbox system 500 of the illustrated example is an EPAS system 502. The EPAS system 502 of the illustrated example has a housing 504 that couples to the vehicle frame 406. The housing 504 has a second housing envelope 506 (e.g., a width in a generally lateral or y-direction). The second housing envelope 506 of the EPAS system 502 of the illustrated example is greater than the first housing envelope 408 of the HPAS system 402. Thus, a second hardpoint connection 512 between the second pitman arm 508 and the drag link 304 is affected or determined by the second housing envelope 506 of the EPAS system 502. The EPAS system 502 of the illustrated example is coupled to the drag link 304 of the steering linkage assembly 208 via the second pitman arm 508. The second pitman arm 508 of the illustrated example has an angled body 510. To accommodate the second housing envelope 506 and provide the second hardpoint connection 512 based on the length L of the drag link 304, the adjustment sleeve 306 and the drag link end 308, the angled body 510 of the second pitman arm 508 is offset outboard (e.g., angled away from the longitudinal axis 414 of the vehicle 100). For example, when coupled to the frame 406, the angled body 510 of the second pitman arm 508 is curved or angled toward the longitudinal axis 414 of the frame 406. Referring to FIGS. 5A and 5C, the second pitman arm 508 includes a first opening 520 to couple to the EPAS system 502 (e.g., the output gear 220) and a second opening 522 opposite the first opening 520 to couple to the drag link 304. For example, referring to FIG. 5C, a longitudinal axis 513 of the angled body 510 is curved or angled between the first opening 520 and the second opening 522. Referring to FIG. 5A, the angled body 510 causes the second opening 522 to be offset laterally (e.g., in the y-direction) relative to the first opening 520 when the second pitman arm 508 is coupled to the vehicle 100. For example, the second hardpoint connection 512 is offset by a first distance 525 from the reference 429 of the frame 406 (e.g., a right side of the frame 406). Additionally, the first opening 520 is offset relative to the frame 406 by a second distance 527 relative to the reference 429 of the frame 406.

Referring to FIGS. 4A and 5A, the first distance 425 and the second distance 525 are substantially similar or equal relative to the reference 429 of the frame 429. To this end, the steering system 102 of the illustrated example employs a common linkage to pitman hardpoint. Referring to FIGS. 4A and 5A, the first hardpoint connection 418 aligns with the second hardpoint connection 512 in the y-direction in relation to the vehicle frame 406 to provide a common hardpoint connection (e.g., the first hardpoint connection 418 and the second hard point connection 512) between the HPAS system 402 and the EPAS system 502. For example, the drag link 304 is configured to couple to the HPAS system 402 and the EPAS system 502. To this end, the drag link 304, the adjustment sleeve 306 and the drag link end 308 have a same overall length L when the HPAS system 402 or the EPAS system 502 is coupled to the vehicle frame 406. Absent a common linkage to pitman hardpoint, different linkage assemblies would be required when using the HPAS system 402 and the EPAS system 502. As a result of having a common linkage to the pitman hardpoint connection, the same steering linkage assembly 208 can be used with the HPAS system 402 or the EPAS system 502, thereby eliminating manufacturing complexity. The common linkage to pitman hardpoint is enabled by employing the first pitman arm 410 having a first shape (e.g., the angled body 412 offset inboard for the HPAS system 402) and the second pitman arm 508 having a second shape (e.g., the angled body 510 offset outboard for the EPAS system 502) different than the first shape. For example, the first opening 420 of the first pitman arm 410 that couples to the HPAS 400 is positioned at a first distance 431 relative to the longitudinal axis 414 of the frame 406 when the first pitman arm 410 is coupled to the vehicle 100. The first opening 520 of the second pitman arm 508 that couples to the EPAS 500 is positioned at a second distance 531 relative to the longitudinal axis 414 of the frame 406 when the second pitman arm 508 is coupled to the vehicle 100, where the first distance 431 is greater than the second distance 531. Nevertheless, the second opening 422 of the first pitman arm 410 aligns with the second opening 522 of the second pitman arm 508 to provide the common linkage to pitman connections 418, 512.

Employing the steering linkage assembly 208 with both the HPAS system 402 and the EPAS system 502 results in an asymmetric number of steering wheel revolutions from straight ahead to full lock left and full lock right. Thus, the steering system 102 of the illustrated example employs a first steering ratio associated with turning the wheels 104A, 104B to the left or a leftward rotational direction and a second steering ratio associated with turning the wheels 104A, 104B to the right or a rightward rotational direction. In other words, the steering system 102 disclosed herein has asymmetric steering relationships between a center steering position and a full left lock position (e.g., left hand turns) and a center steering position and a full right lock position (e.g., right hand turns). For example, a first steering ratio means that rotating the steering wheel 106 x degrees in a counterclockwise rotation from a center position (e.g., left rotation) causes the steering angle 110 of the wheels 104A, 104B to turn y degrees. In contrast, a second steering ratio means that rotating the steering wheel 106 x degrees in a clockwise rotation from a center position (e.g., right rotation) causes the steering angle 110 of the wheels 104A, 104B to turn z degrees, where y degrees is different than the z degrees. In other words, a same absolute degree of rotation of the steering wheel 106 in the left direction and in the right direction does not provide a same absolute steering angle 110 of the wheels 104A, 104B. In other words, to rotate the wheels 104A, 104B with a steering angle of 20 degrees in a left rotational direction may require a leftward rotation of the steering wheel 106 to a SWA of approximately 60 degrees, but rotating the wheels 104A, 104B to a steering angle of 20 degrees in a right rotational direction may require a rightward rotation of the steering wheel 106 to a SWA of approximately 50 degrees.

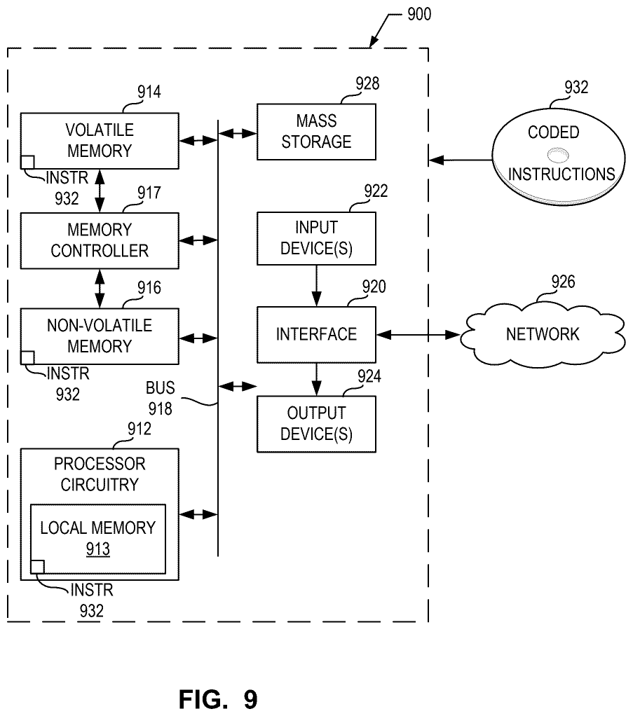

FIG. 6 is a schematic overview of an example system 600 disclosed herein to compensate for asymmetric steering of the steering system 102 disclosed herein when employing advanced driving assistance systems or hands-free driving operations. As noted above, the steering ratios for left handed turns and right handed turns are asymmetric. The first and second sets of ratios are provided by Ackermann steering principles. Thus, the steering controller circuitry 210 of the illustrated example employs a first set of data 602 providing RWA-to-SWA ratios (e.g., a first steering ratio) associated with a left turn event (e.g., or steering angles 110 directed in a leftward rotational direction) and a second set of data 604 providing RWA-to-SWA ratios (e.g., a second steering ratio) associated with a right turn event (or steering angles 110 directed in a rightward rotational direction). For example, a change in a steering pinion angle (SPA) of the steering gear 202 causes a corresponding change of the steering angle 110 of the wheels 104A, 104B based on the first steering ratio provided by the first set of data 602 and the second steering ratio provided by the second set of data 604 of the steering system 102. An SWA (e.g., provided by the SWA sensor 212) correlates with an SPA of the steering gear 202 (e.g., a one-to-one correlation, a two-to-one correlation, etc.). Thus, the example system 600 determines a target SPA of the steering gear 202 based on an RWA request 610 (e.g., a desired vehicle travel path) provided by the ADAS 218 and a conversion of the RWA to the SWA provided by the first set of data 602 or the second set of data 604 during, for example, an autonomous, backup assist, lane assist and/or other hands-free driving event(s). Specifically, the system 600 of the illustrated example splits or separates an SPA determination associated with an RWA requests from the ADAS 218 between a left turn process 606 and right turn process 608. In other words, the system 600 determines an SPA associated with a left hand RWA request independently and/or separately from a determination of an SPA associated with a right hand RWA request.

The SPA is not measured but determined by a correlation with the SWA. The SPA can be determined as follows:
EQ1: SPA=steering ratio (SR)*RWA, where the SPA correlates with the SWA associated with the first set of data 602 and/or the second set of data 604 providing RWA-to-SWA ratios (e.g., a one-to-one correlation).

In operation, the steering controller circuitry 210 of the illustrated example receives the RWA request 610 from, for example, the ADAS 218. The steering controller circuitry 210 includes the first set of data 602 associated with a left turn event and the second set of data 604 associated with a right turn event. Thus, after receiving the RWA request 610 from the ADAS 218, the steering controller circuitry 210 determines whether a direction of the RWA request is a left turn or leftward direction (e.g., a counterclockwise rotation of the steering wheel 106) or a right turn or rightward direction (e.g., a clockwise rotation of the steering wheel 106). Thus, the steering controller circuitry 210 determines if the RWA request 610 is a left turn RWA request 610a or a right turn RWA request 610b. Based on the direction of the RWA request 610a, 610b (e.g., a steering angle request), the steering controller circuitry 210 obtains an SWA request 612 from the first set of data 602 (e.g., RWA-to-SWA ratios) in response to determining that the left turn RWA request 610a, or obtains an SWA request 614 from the second set of data 604 (e.g., RWA-to-SWA ratios) in response to determining that the right turn RWA request 610b.

The steering controller circuitry 210 can also be configured to verify if the SWA and the steering wheel rate associated with the RWA request 610a, 610b is within acceptable operating thresholds 616 (e.g., within operating domain limits). In some examples, if the SWA request 612 or 614 associated with the RWA request 610a or 610b, respectively, exceeds the operating threshold ranges, the RWA request 610a, 610b can be cancelled. In some examples, if the SWA request 612 or 614 associated with the RWA request 610a or 610b, respectively, exceeds the operating threshold ranges, the SWA request 612 or 614 can be adjusted based on maximum allowable thresholds (e.g., maximum allowable SWA angle and/or rate). Thus, instead of cancelling the RWA request, the SWA request 612 or 614 is modified or adjusted based on the maximum operational design domain (ODD).

The steering controller circuitry 210 is configured to determine a relative SPA 618 (e.g., a steering angle offset 620) based on the RWA request 610a or 610b associated with the corresponding determined SWA request 612 or determined SWA request 614. For example, steering angle offset 620 is determined by:
EQ2: Steering Angle Offset=(Relative Angle)−(Compensated Angle).

where, relative angle is based on a center position of a SPA of the steering gear 202 (e.g., a mid-point rotational position between fully left lock-to-fully right lock position of the steering gear 202), and compensated angle is a current position of an SPA (e.g., an SWA provided by the SWA sensor 212) based on a current direction of a vehicle (e.g., a straight ahead position of the vehicle).

The steering angle offset 620 can be dynamically and/or continuously determined by using the compensated angle and the relative angle relationship. Such relationship correlates to a determination of a relative SPA needed to control the vehicle 100 based on a desired steering angle of the RWA request 610a or 610b. For example, the relative SPA 618 is based on a difference between a current position of the SPA (e.g., provided by the SWA sensor 212) and a target position of the SPA that correlates with the RWA request 610a or 610b. In other words, if the vehicle 100 is in a straight ahead position and the SPA is at zero degrees, the relative angle is zero. Thus, an RWA request 610a or 610b requiring a steering angle of 20 degrees of the wheels 104A, 104B is determined by the target SWA minus the current SWA. Additionally, steering angle offset 620 can include other adjustments that may be caused by other conditions like cross-winds, vehicle speed, road angle, road tilt, and/or any other environmental factor(s). The steering controller circuitry 210 commands the PAS system 204 (e.g., the HPAS system 400 or the EPAS system 500) to move the steering gear 202 to the relative SPA 618, which causes the vehicle 100 to move in the direction of the requested travel path provided by the ADAS 218.

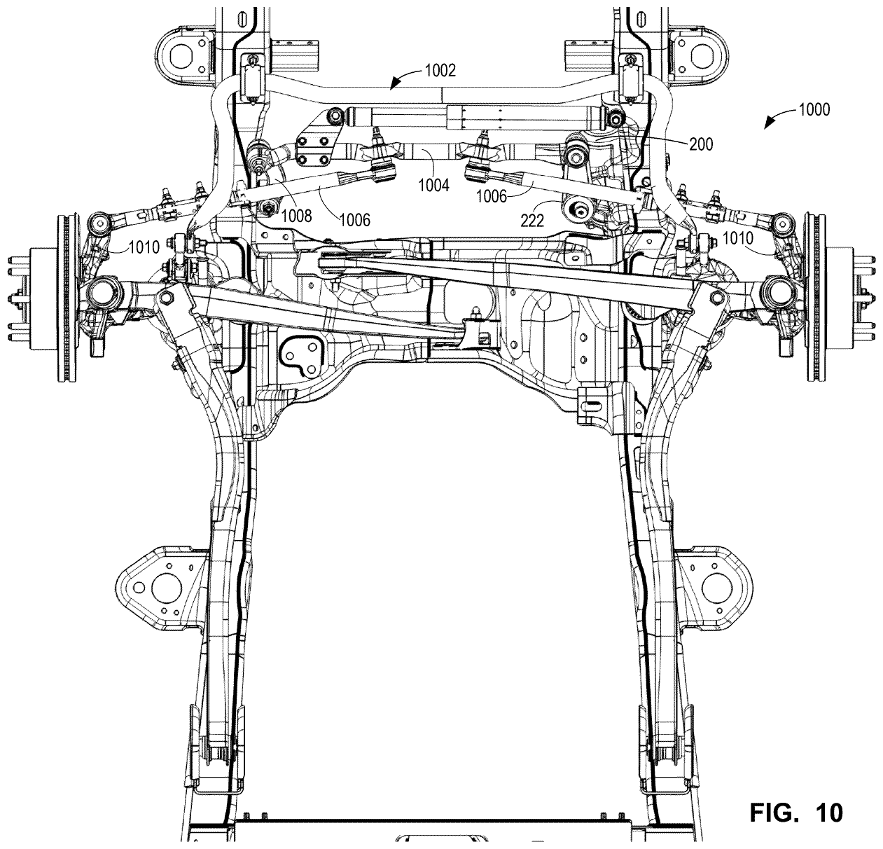

FIG. 7 is a block diagram of an example implementation of the steering controller circuitry 210 of the steering system 102 of FIG. 2. The steering controller circuitry 210 operates the steering gear 202 and/or the PAS system 204 of the vehicle 100. The steering control circuitry 210 of FIG. 7 may be instantiated (e.g., creating an instance of, bring into being for any length of time, materialize, implement, etc.) by programmable circuitry such as a Central Processor Unit (CPU) executing first instructions. Additionally or alternatively, the steering controller circuitry 210 of FIG. 7 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

The example steering controller circuitry 210 includes example road wheel angle (RWA) request circuitry 702, example road wheel angle (RWA) direction circuitry 704, example road wheel angle-to-steering wheel angle (RWA-to-SWA) conversion circuitry 706, example steering wheel angle (SWA) verification circuitry 708, and example offset angle determiner circuitry 710.

The example RWA request circuitry 702 receives RWA requests (e.g., the RWA request 610 of FIG. 6) from the ADAS 218. The request can be an autonomous driving request, a hands-free driving request, a lane departure assist, a trailer backup assist, and/or any other hands-free request(s). As used herein, hands-free request means that the steering angle 110 of the wheels 104A, 104B is provided by the steering system 102 without (e.g., user) input from the steering wheel 106.

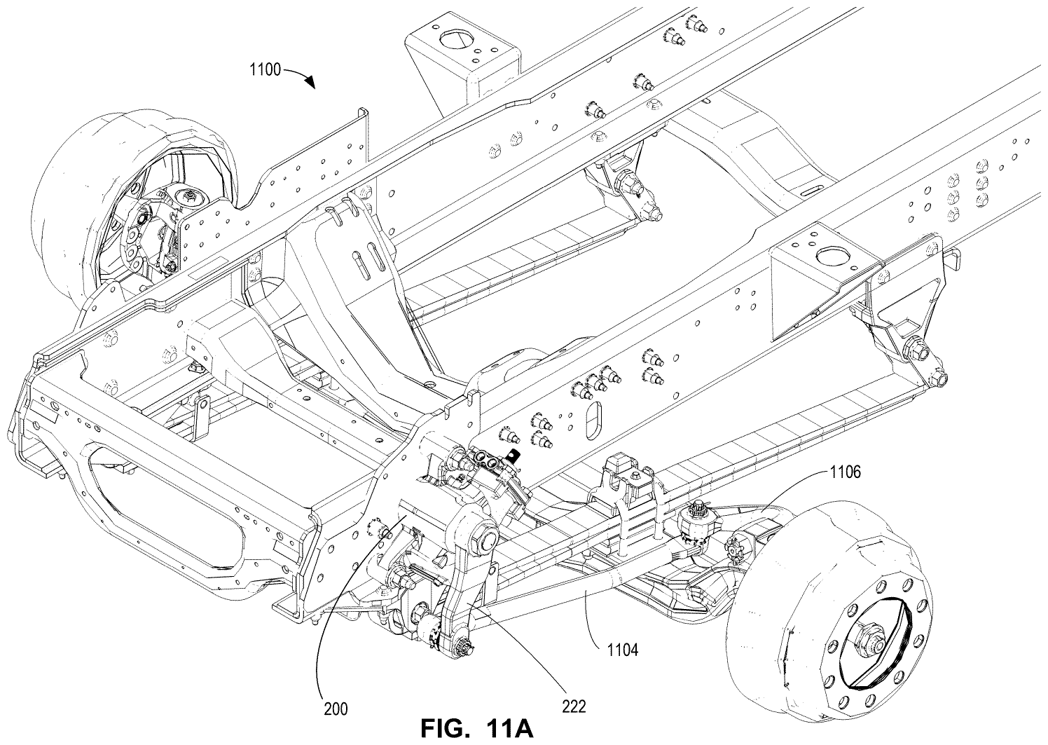

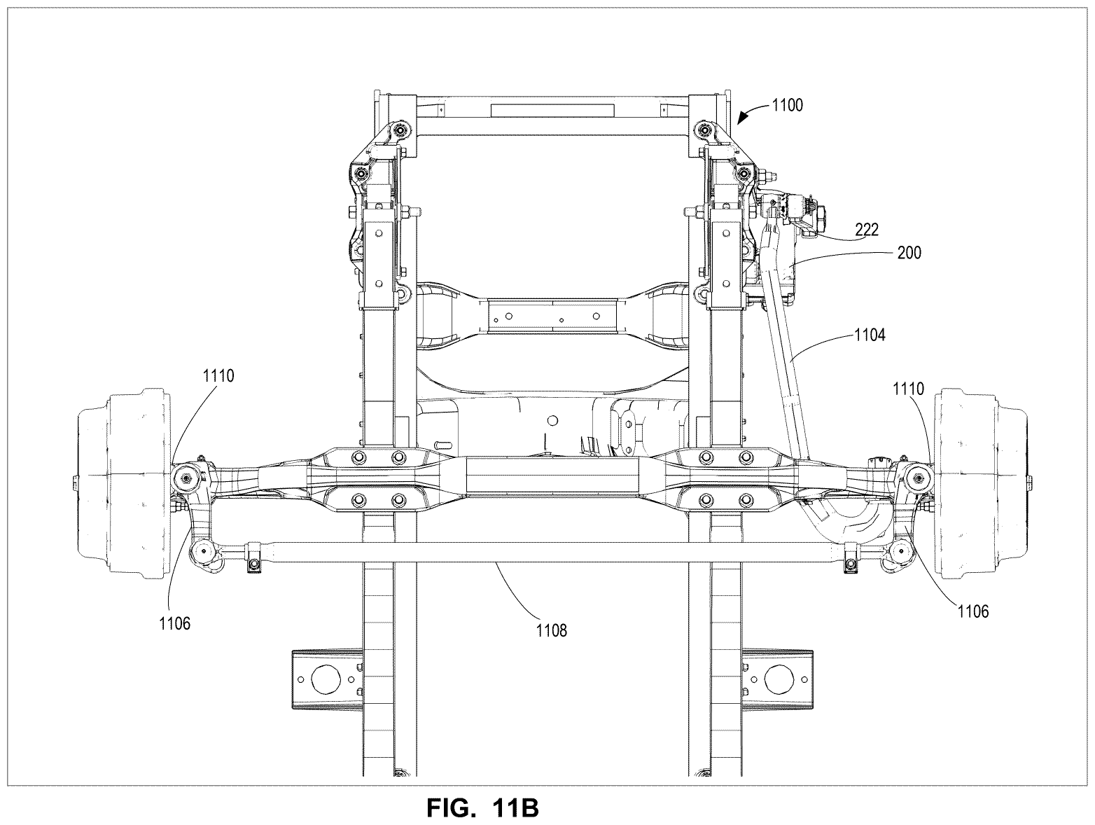

In some examples, the RWA request circuitry 702 is instantiated by programmable circuitry executing RWA request instructions and/or configured to perform operations such as those represented by the flowchart of FIG. 8. In some examples, the RWA request circuitry 702 includes means for determining, retrieving, and/or obtaining a RWA request, a steering angle, and/or a travel path of the vehicle 100. For example, the means for determining may be implemented by the RWA request circuitry 702. In some examples, the RWA request circuitry 702 may be instantiated by programmable circuitry such as the example programmable circuitry 900 of FIG. 9. For instance, the RWA request circuitry 702 may be instantiated by a microprocessor executing machine executable instructions such as those implemented by at least blocks 912, 914, 916 of FIG. 9. In some examples, the RWA request circuitry 702 may be instantiated by hardware logic circuitry, which may be implemented by an ASIC, XPU, or the FPGA circuitry configured and/or structured to perform operations corresponding to the machine readable instructions. Additionally or alternatively, the RWA request circuitry 702 may be instantiated by any other combination of hardware, software, and/or firmware. For example, the RWA request circuitry 702 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example RWA direction circuitry 704 determines a direction of movement needed based on the RWA request received by the RWA request circuitry 702. For example, the RWA direction circuitry 704 includes a comparator to compare the RWA request to a threshold. In the illustrated example, the threshold is a value of zero (e.g., zero degrees). Specifically, the threshold value is a rotational value or position of the steering wheel 106 that directs the steering angle of the wheels 104A, 104B in a straight direction. In other words, the threshold is a center rotational value of the steering wheel 106 and/or the SPA that causes the vehicle 100 to move in a straight (e.g., non-turning) direction. In operation, the RWA direction circuitry 704 determines the RWA request 610 is a left turn RWA request 610a when the RWA request 610 is greater than the threshold and determines the RWA request 610 is a right turn RWA request 610b when the RWA request 610 is less than the threshold.

In some examples, the RWA direction circuitry 704 is instantiated by programmable circuitry executing RWA request instructions and/or configured to perform operations such as those represented by the flowchart of FIG. 8. In some examples, the RWA direction circuitry 704 includes means for determining a direction of a RWA request and/or a travel path of the vehicle 100. For example, the means for determining may be implemented by the RWA direction circuitry 704. In some examples, the RWA direction circuitry 704 may be instantiated by programmable circuitry such as the example programmable circuitry 900 of FIG. 9. For instance, the RWA direction circuitry 704 may be instantiated by a microprocessor executing machine executable instructions such as those implemented by at least blocks 912, 914, 916 of FIG. 9. In some examples, RWA direction circuitry 704 may be instantiated by hardware logic circuitry, which may be implemented by an ASIC, XPU, or the FPGA circuitry configured and/or structured to perform operations corresponding to the machine readable instructions. Additionally or alternatively, the RWA direction circuitry 704 may be instantiated by any other combination of hardware, software, and/or firmware. For example, the RWA direction circuitry 704 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The RWA-to-SWA conversion circuitry 706 receives the detected RWA request 610a or 610b and determines a corresponding SWA associated with the RWA request 610a, 610b. Based on the detected RWA request 610a or 610b, the RWA direction circuitry 704 obtains an SWA value from the first set of data 602 (e.g., RWA-to-SWA correlation values) or an SWA value from the second set of data 604 (e.g., RWA-to-SWA correlation values). For example, when the RWA direction circuitry 704 determines that the RWA request 610 is greater than the threshold (e.g., the RWA request 610a) (e.g., indicative of a left hand turn), the RWA-to-SWA conversion circuitry 706 determines a corresponding SWA that correlates with the RWA request 610a from the first set of data 602 (e.g., the SWA request 612 of FIG. 6). In contrast, when the RWA direction circuitry 704 determines that the RWA request 610 is less than the threshold (e.g., the RWA request 610b) (e.g., indicative of a right hand turn), the RWA-to-SWA conversion circuitry 706 determines a corresponding SWA that correlates with the RWA request 610b from the second set of data 604 (e.g., the SWA request 614 of FIG. 6).

The first set of data 602 and the second set of data 604 (e.g., the RWA-to-SWA ratios) can be determined from testing. The values determined from testing can be provided in separate or isolated look-up tables, the first set of data 602 associated with left hand turns and the second set of data 604 associated with the right hand turns. For example, for each one-degree rotational angle of the steering wheel 106 from a center position to a full lock left rotational position, corresponding steering angles of the wheels 104A, 104B can be measured and the steering ratio for the left hand rotation of the steering wheel 106 can be determined. Likewise, for each one-degree rotational angle of the steering wheel 106 from a center position to a full lock right rotational position, corresponding steering angles of the wheels 104A, 104B can be measured and the steering ratio for the right hand rotations of the steering wheel 106 can be determined. In some examples, a first functional equation or algorithm (e.g., based on Ackermann steering principles) can be used to provide, determine or otherwise calculate a correlation between the RWA request and a corresponding SWA for each left rotational position of the steering wheel, and a second functional equation or algorithm can be used to provide a correlation between the RWA request and a corresponding SWA for each right rotational position of the steering wheel.

In some examples, the RWA-to-SWA conversion circuitry 706 is instantiated by programmable circuitry executing RWA request instructions and/or configured to perform operations such as those represented by the flowchart of FIG. 8. In some examples, the RWA-to-SWA conversion circuitry 706 includes means for converting, determining, or obtaining SWAs based on the road RWA requests. For example, the means for determining may be implemented by RWA-to-SWA conversion circuitry 706. In some examples, the RWA-to-SWA conversion circuitry 706 may be instantiated by programmable circuitry such as the example programmable circuitry 900 of FIG. 9. For instance, the RWA-to-SWA conversion circuitry 706 may be instantiated by a microprocessor executing machine executable instructions such as those implemented by at least blocks 912, 914, 916 of FIG. 9. In some examples, the RWA-to-SWA conversion circuitry 706 may be instantiated by hardware logic circuitry, which may be implemented by an ASIC, XPU, or the FPGA circuitry configured and/or structured to perform operations corresponding to the machine readable instructions. Additionally or alternatively, the RWA-to-SWA conversion circuitry 706 may be instantiated by any other combination of hardware, software, and/or firmware. For example, the RWA-to-SWA conversion circuitry 706 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example SWA verification circuitry 708 determines if the SWA request 612 or 614 is within an operating threshold. In general, after the SWA (e.g., the SWA request 612 or the SWA request 614) is determined from either the first set of data 602 or the second set of data 604, the steering controller circuitry 210 determines if the SWA and/or the SWA rate associated with the SWA request 612 or the SWA request 614 are within threshold operating parameters. For example, if the SWA and the SWA rate are within operating threshold ranges, the steering controller circuitry 210 proceeds with the RWA request. However, if the SWA and the SWA rate are not within operating threshold ranges, the steering controller circuitry 210 can cancel the request. For example, if the SWA request 612 or the SWA request 614 requires an SWA and/or an SWA rate that exceeds an operating threshold, the SWA verification circuitry 708 can cancel or ignore the RWA requestor, alternatively, adjust the SWA request 612 or the SWA request 614 based on a maximum value of the operating threshold (e.g., maximum allowable SWA angle and/or SWA rate). Thus, instead of cancelling the RWA request, the SWA request 612, 614 is modified or adjusted based on a maximum ODD. For instance, the SWA verification circuitry 708 determines if the SWA is within an SWA threshold based on a direction of the vehicle 100 and/or a speed of the vehicle 100 (e.g., provided by feedback signals from the SWA sensor 212, the steering wheel torque sensor 214 and the speed sensor 216). Additionally, the SWA verification circuitry 708 of the illustrated example determines if a SWA rate associated with the SWA is within a rate threshold (e.g., based on a vehicle speed provided by the speed sensor 216). For example, if the SWA based on the SWA request 612 or the SWA request 614 requires a rapid or fast rotation of the steering wheel and/or SPA (i.e., the SWA rate exceeds the rate threshold) based on a speed of the vehicle, the SWA verification circuitry 708 can cancel the RWA request 610a, 610b or adjust the SWA request 612, 614 based on a maximum allowable SWA and/or SWA rate associated with the operating threshold. If the SWA verification circuitry 708 determines that the SWA and/or the SWA rate associated with the SWA request 612 or the SWA request 614 does not exceed the operating threshold, the SWA verification circuitry 708 instructs the offset angle determiner circuitry 710 to proceed.

In some examples, the SWA verification circuitry 708 is instantiated by programmable circuitry executing RWA request instructions and/or configured to perform operations such as those represented by the flowchart of FIG. 8. In some examples, the SWA verification circuitry 708 includes means for verifying that the determined SWA based on the RWA request is acceptable or within operating parameters (e.g., a SWA and/or SWA rate are within acceptable threshold based on a vehicle and/or direction of the vehicle 100). For example, the means for determining may be implemented by the SWA verification circuitry 708. In some examples, the SWA verification circuitry 708 may be instantiated by programmable circuitry such as the example programmable circuitry 900 of FIG. 9. For instance, the SWA verification circuitry 708 may be instantiated by a microprocessor executing machine executable instructions such as those implemented by at least blocks 912, 914, 916 of FIG. 9. In some examples, the SWA verification circuitry 708 may be instantiated by hardware logic circuitry, which may be implemented by an ASIC, XPU, or the FPGA circuitry configured and/or structured to perform operations corresponding to the machine readable instructions. Additionally or alternatively, the SWA verification circuitry 708 may be instantiated by any other combination of hardware, software, and/or firmware. For example, the SWA verification circuitry 708 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example offset angle determiner circuitry 710 determines an offset angle (e.g., the steering angle offset 620 of FIG. 6), which correlates with a target or relative SPA (e.g., the relative SPA 618 of FIG. 6) needed to direct the vehicle 100 based on the SWA request 612 or the SWA request 614 (e.g., provided by the RWA request 610 of FIG. 6) (see EQ 1 and/or EQ 2 noted above). For example, the offset angle determiner circuitry 710 determines the relative SPA based on a difference between a current position of the SPA (e.g., provided by the SWA sensor 212) and a target position of the SPA provided by the SWA request 612 or the SWA request 614 associated with the RWA request 610a or 610b, respectively. The offset angle determiner circuitry 710 can determine other factors including, for example, crosswind, road slope, road tilt, and/or any other condition(s).

In some examples, the offset angle determiner circuitry 710 is instantiated by programmable circuitry executing RWA request instructions and/or configured to perform operations such as those represented by the flowchart of FIG. 8. In some examples, the offset angle determiner circuitry 710 includes means for determining a SWA offset based on the RWA request. For example, the means for determining may be implemented by the offset angle determiner circuitry 710. In some examples, the offset angle determiner circuitry 710 may be instantiated by programmable circuitry such as the example programmable circuitry 900 of FIG. 9. For instance, the offset angle determiner circuitry 710 may be instantiated by a microprocessor executing machine executable instructions such as those implemented by at least blocks 912, 914, 916 of FIG. 9. In some examples, the offset angle determiner circuitry 710 may be instantiated by hardware logic circuitry, which may be implemented by an ASIC, XPU, or the FPGA circuitry configured and/or structured to perform operations corresponding to the machine readable instructions. Additionally or alternatively, the offset angle determiner circuitry 710 may be instantiated by any other combination of hardware, software, and/or firmware. For example, the offset angle determiner circuitry 710 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the steering controller circuitry 210 of FIG. 2 is illustrated in FIG. 7, one or more of the elements, processes, and/or devices illustrated in FIG. 7 may be combined, divided, re-arranged, omitted, eliminated, and/or implemented in any other way. Further, the example RWA request circuitry 702, the example RWA direction circuitry 704, the example RWA-to-SWA conversion circuitry 706, the example SWA verification circuitry 708, and the example offset angle determiner circuitry 710 and/or, more generally, the example steering controller circuitry 210 of FIG. 7, may be implemented by hardware alone or by hardware in combination with software and/or firmware. Thus, for example, any of the example RWA request circuitry 702, the example RWA direction circuitry 704, the example RWA-to-SWA conversion circuitry 706, the example SWA verification circuitry 708, and the example offset angle determiner circuitry 710 and/or, more generally, the example steering controller circuitry 210 of FIG. 7, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example steering controller circuitry 210 of FIG. 7 may include one or more elements, processes, and/or devices in addition to, or instead of, those illustrated in FIG. 7, and/or may include more than one of any or all of the illustrated elements, processes, and devices.

A flowchart representative of example machine readable instructions, which may be executed by programmable circuitry to implement and/or instantiate the example steering controller circuitry 210 of FIG. 7 and/or representative of example operations which may be performed by programmable circuitry to implement and/or instantiate the example steering controller circuitry 210 of FIG. 7, are shown in FIG. 8. The machine readable instructions may be one or more executable programs or portion(s) of one or more executable programs for execution by programmable circuitry such as the programmable circuitry 912 shown in the example programmable circuitry platform 900 discussed below in connection with FIG. 9 and/or may be one or more function(s) or portion(s) of functions to be performed by the example programmable circuitry. In some examples, the machine readable instructions cause an operation, a task, etc., to be carried out and/or performed in an automated manner in the real world. As used herein, “automated”means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 8, many other methods of implementing the example steering controller circuitry 210 of FIG. 7 may alternatively be used. For example, the order of execution of the blocks of the flowcharts may be changed, and/or some of the blocks described may be changed, eliminated, duplicated, or combined. Additionally or alternatively, any or all of the blocks of the flow chart may be implemented by one or more hardware circuits (e.g., processor circuitry, discrete and/or integrated analog and/or digital circuitry, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks, and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic, and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or RAID systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 8 is a flowchart representative of example machine readable instructions and/or example operations 800 that may be executed, instantiated, and/or performed by example programmable circuitry to account for asymmetric steering ratios during hands-free and/or self-driving event(s). The example machine-readable instructions and/or the example operations 800 of FIG. 8 begin at block 802, at which the example RWA request circuitry 702 obtains, receives, and/or otherwise retrieves a desired RWA request. For example, the RWA request circuitry 702 receives the RWA request 610 from the ADAS 218.

At block 804, the RWA direction circuitry 704 determines if the RWA request is less than a threshold. For example, the threshold can be a value of zero (0). If at block 804 the RWA direction circuitry 704 determines that the RWA request is not less than the threshold, the process moves to block 806.

At block 806, the RWA direction circuitry 704 determines if the RWA request is greater than the threshold. For example, the RWA direction circuitry 704 determines if an angle associated with the RWA request 610 is greater than zero.

If at block 806 the RWA direction circuitry 704 does not determine that the RWA request is greater than the threshold, the process returns to block 802.

If at block 806 the RWA direction circuitry 704 determines that the RWA request is greater than the threshold (e.g., the RWA request 610a of FIG. 6), the RWA direction circuitry 704 communicates to the RWA-to-SWA conversion circuitry 706 that the RWA request (e.g., the RWA request 610a of FIG. 6) is greater than the threshold (e.g., greater than zero indicative of a left hand turn or left angle request).

At block 808, the RWA-to-SWA conversion circuitry 706 employs a left side asymmetric steering ratio (LSR). For example, the RWA-to-SWA conversion circuitry 706 uses the first set of data 602 associated with the RWA request 610a.

Next, at block 810, the RWA-to-SWA conversion circuitry 706 obtains, retrieves, calculates, and/or otherwise determines the SWA associated with the RWA request based on the LSR. For example, the RWA-to-SWA conversion circuitry 706 retrieves the SWA (e.g., the SWA request 612) associated with the RWA request 610a from the first set of data 602. The process then moves to block 816.

Returning to block 804, if the RWA direction circuitry 704 determines that the RWA request is less than the threshold (e.g., a zero value), the RWA direction circuitry 704 communicates to the RWA-to-SWA conversion circuitry 706 that the RWA request (e.g., the RWA request 610b of FIG. 6) is less than the threshold (e.g., less than zero indicative of a right hand turn or right angle request). The process then moves to block 812.

At block 812, the RWA-to-SWA conversion circuitry 706 employs a right side asymmetric steering ratio (RSR). For example, the RWA-to-SWA conversion circuitry 706 uses the second set of data 604 associated with the RWA request 610b.

Next, at block 814, the RWA-to-SWA conversion circuitry 706 obtains, retrieves, calculates, and/or otherwise determines the SWA (e.g., the SWA 614 of FIG. 6) associated with the RWA request 610b based on the RSR. For example, the RWA-to-SWA conversion circuitry 706 retrieves the SWA (e.g., the SWA request 614) associated with the RWA request 610b from the second set of data 604.

At block 816, the example SWA verification circuitry 708 determines if the SWA request is within acceptable threshold limits. For example, the example SWA verification circuitry 708 determines if the SWA request 612 (e.g., block 810) or the SWA request 614 (e.g., block 814) determined by the RWA-to-SWA conversion circuitry 706 is within an acceptable threshold angle limits based on, for example, a speed of the vehicle, a current travel path of the vehicle, crosswind conditions, road conditions and/or slopes and/or any other condition(s). If the SWA request 612, 614 is not within acceptable threshold angle limits, the steering control circuitry 210 cancels the RWA request 610a or 610b and maintains a direction of the vehicle 100 and/or a position of the steering gear 202. If the SWA verification circuitry 708 determines that the SWA request 612, 614 is within acceptable threshold angle limits, the SWA verification circuitry 708 determines if an SWA rate needed to move the steering wheel based on the SWA request 612, 614 exceeds a rate threshold.

If the SWA verification circuitry 708 determines that the SWA rate associated with the SWA request 612, 614 is not within an acceptable threshold angle limit (block 816), the process 800 ends and the steering control circuitry 210 cancels the RWA request 610a or 610b. If the SWA verification circuitry 708 determines that the SWA rate associated with the SWA request 612, 614 is within acceptable threshold angle limits (block 816), the process 800 proceeds with the SWA request 612, 614.

The steering controller circuitry 210 converts the determined SWA to a relative SPA (block 818). For example, the example offset angle determiner circuitry 710 determines an offset angle, which correlates with a target or relative SPA needed to direct the vehicle 100 based on the RWA request. For example, the offset angle determiner circuitry 710 determines the relative SPA based on a difference between a current position of the SPA (e.g., provided by the SWA sensor 212) and a target position of the SPA provided by the SWA associated with the SWA request 612, 614. The offset angle determiner circuitry 710 can determine other factors for determining an offset angle including, for example, crosswind, road slope, road tilt, and/or any other condition(s).

At block 820, the example offset angle determiner circuitry 710 instructs the PAS system 204 to move the steering gear 202 to the relative SPA determined by the offset angle determiner circuitry 710. The process ends or returns to block 802.

FIG. 9 is a block diagram of an example programmable circuitry platform 900 structured to execute and/or instantiate the example machine-readable instructions and/or the example operations of FIG. 8 to implement the example steering controller circuitry 210 of FIGS. 2 and 7. The programmable circuitry platform 900 can be, for example, a server, a personal computer, a workstation, a self-learning machine (e.g., a neural network), a mobile device (e.g., a cell phone, a smart phone, a tablet), or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the example steering controller circuitry 210, the example RWA request circuitry 702, the example RWA direction circuitry 704, the example RWA-to-SWA conversion circuitry 706, the example SWA verification circuitry 708, the example offset angle determiner circuitry 710, the first set of RWA-to-SWA ratios 714, and the second set of RWA-to-SWA ratios 716.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, and/or speaker. The interface circuitry 920 of the illustrated example, thus, includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIG. 8, may be stored in the mass storage device 928, in the volatile memory 914, in the non-volatile memory 916, and/or on at least one non-transitory computer readable storage medium such as a CD or DVD which may be removable.

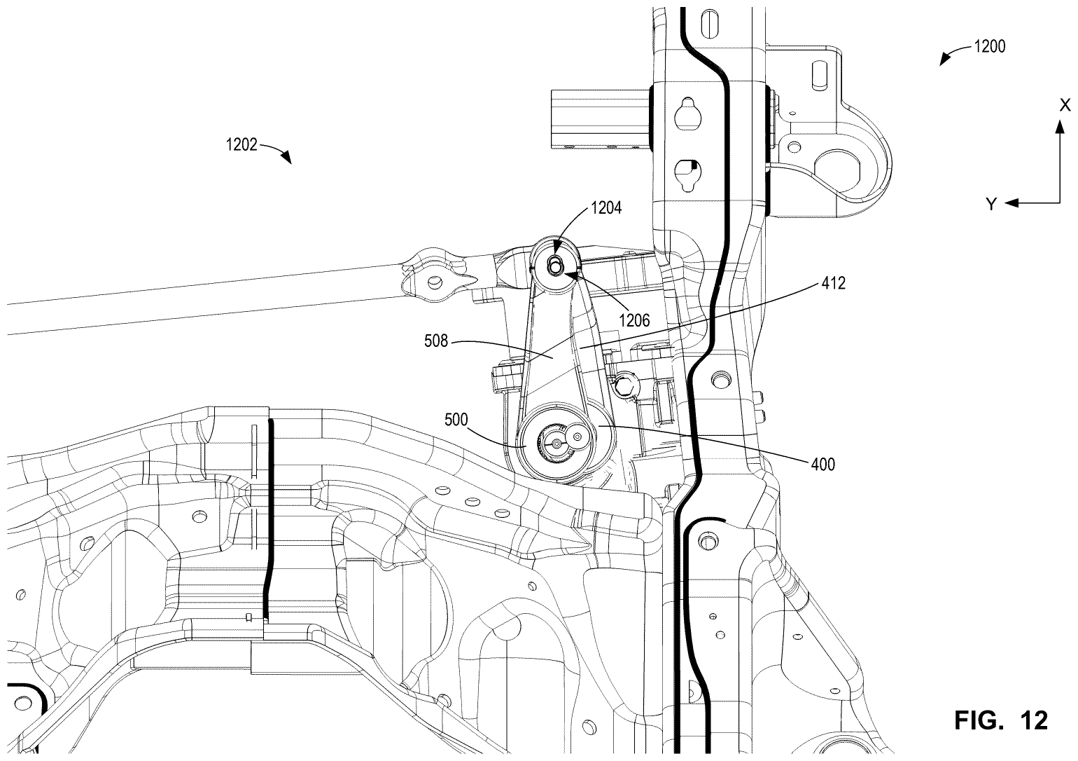

FIG. 10 is a bottom view of another example vehicle 1000 disclosed herein having another example steering linkage assembly 1002 in which examples disclosed herein can be implemented. The steering linkage assembly 1002 of the illustrated example is a non-driven, independent axle two-wheel drive steering assembly (e.g., 4×2 drivetrain, front-wheel drive, etc.). The steering linkage assembly 1002 has a plurality of mechanical components that operatively couple the pitman arm 222 and wheels (the wheels 104A, 104B) of the vehicle 1000. In the illustrated example, the steering linkage assembly 1002 includes a center link 1004, tie rods 1006, an idler arm 1008, the pitman arm 222 and the steering gearbox 200. The center link 1004 is coupled to the pitman arm 222. The tie rods 1006 couple the center link 1004 and respective knuckles 1010 of the vehicle 1000. Thus, rotation of the pitman arm 222 via the steering gearbox 200 causes rotation of the knuckles 1010 via the tie rods 1006 and the center link 1004. The steering gearbox 200 of the illustrated example can be implemented with the HPAS system 400 or the EPAS system 500. Additionally, the pitman arm 222 can be implemented with the first pitman arm 410 or the second pitman arm 508. In other words, the steering linkage assembly 1002 is the same whether the HPAS system 400 is coupled to the vehicle 1000 or the EPAS system 500 is used with the vehicle 1000. The vehicle 1000 of the illustrated example includes the steering control circuitry 210.

FIG. 11A is a perspective, side view of another example vehicle 1100 in which the examples disclosed herein can be implemented. FIG. 11B is a bottom view of the example vehicle 1100 of FIG. 11A. The vehicle 1100 of the illustrated example has a steering linkage assembly 1102 that provides a fore-aft force or drag link assembly to turn a steering angle of the vehicle 1100 (e.g., a 4×2 drivetrain). In the illustrated example, the steering linkage assembly 1102 includes a drag link 1104, steering arms 1106, a tie rod tube 1108, the pitman arm 222 and the steering gearbox 200. The drag link 1104 is coupled to the pitman arm 222, which is coupled to the steering gearbox 200. The tie rod tube 1108 couples the steering arms 1106. The steering arms 1106 operatively couple the drag link 1104 and respective knuckles 1110 of the vehicle 1100. Thus, rotation of the pitman arm 222 via the steering gearbox 200 causes the drag link 1104 to move in a fore-aft direction, which in turn causes rotation of the knuckles 1110 via the steering arms 1106 and the tie rod tube 1108. The steering gearbox 200 of the illustrated example can be implemented with the HPAS system 400 or the EPAS system 500. Additionally, the pitman arm 222 can be implemented with the first pitman arm 410 or the second pitman arm 508. In other words, the steering linkage assembly 1102 is the same whether the HPAS system 400 is coupled to the vehicle 1000 or the EPAS system 500 is used with the vehicle 1100. The vehicle 1100 of the illustrated example includes the steering control circuitry 210.

FIG. 12 is a bottom view of another example vehicle 1200 in which the examples disclosed herein can be implemented. In the illustrated example, the HPAS system 400 is overlayed with the EPAS system 500. The vehicle 1200 includes a steering linkage assembly 1202 having a first linkage to pitman hardpoint 1204 between the steering linkage assembly 1202 and the HPAS system 400. The steering linkage assembly 1202 has a second linkage to pitman hardpoint 1206 between the steering linkage assembly 1202 and the EPAS system 500. In the illustrated example, the first linkage to pitman hardpoint 1204 is offset relative to the second linkage to pitman hardpoint 1206 in the x-direction. Although the first linkage to pitman hardpoint 1204 is offset relative to the second linkage to pitman hardpoint 1206 in the x-direction, the first linkage to pitman hardpoint 1206 and the second linkage to pitman hardpoint align in the y-direction. Therefore, a common linkage assembly can be employed with the HPAS system 400 and the EPAS system 500.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable the same steering linkage assembly to be used with a hydraulic power steering assist system or an electric power steering assist system. Disclosed systems, apparatus, articles of manufacture, and methods to account for asymmetric steering ratios as a result of using a common or the same linkage assembly with the HPAS system or the EPAS system. Disclosed systems, apparatus, articles of manufacture, and methods are accordingly directed to the operation of a vehicle.

Example methods, apparatus, systems, and articles of manufacture to account for asymmetric steering ratios are disclosed herein. Further examples and combinations thereof include the following:
Example 1 includes an apparatus comprising a steering linkage assembly including a drag link having a first end and a second end opposite the first end, the drag link configured to couple to a hydraulic power assist system and an electric power assist system, the hydraulic power assist system to couple to a vehicle frame and the first end of the drag link via a first pitman arm, the electric power assist system to couple to the vehicle frame and the first end of the drag link via a second pitman arm, the first pitman arm differently shaped than the second pitman arm to enable the first pitman arm and the second pitman to have a common pitman to hardpoint connection with the drag link of the steering linkage assembly.
Example 2 includes the apparatus of example 1, wherein the steering linkage assembly provides an asymmetric number of steering wheel revolutions between straight ahead and full lock left and full lock right.
Example 3 includes the apparatus of examples 1 or 2, wherein the drag link has a same length when the hydraulic power assist system or the electric power assist system is coupled to the vehicle frame.
Example 4 includes the apparatus of any one of examples 1-3, wherein the steering linkage assembly further includes a tie rod end, the tie rod end to couple to the second end of the drag link, and an adjustment sleeve to couple the drag link and the drag link end.
Example 5 includes the apparatus of any one of examples 1-4, wherein the drag link, the drag link end, and the adjustment sleeve have same respective lengths when the hydraulic power assist system or the electric power assist system is coupled to the vehicle frame.
Example 6 includes the apparatus of any one of examples 1-5, wherein the first pitman arm is tilted inboard relative to the vehicle frame to couple to the hydraulic power assist system and the drag link.
Example 7 includes the apparatus of any one of examples 1-6, wherein the second pitman arm is tilted outboard relative to the vehicle frame to couple the electric power assist system and the drag link.
Example 8 includes the apparatus of any one of examples 1-7, wherein a first opening of the first pitman arm that couples to the hydraulic power assist system is positioned at a first distance relative to a longitudinal axis of the frame when the first pitman arm is coupled to the vehicle, a second opening of the second pitman arm that couples to the electric power assist system is positioned at a second distance relative to the longitudinal axis of the frame when the second pitman arm is coupled to the vehicle, wherein the first distance is greater than the second distance.
Example 9 includes an apparatus comprising interface circuitry, machine readable instructions, and programmable circuitry to at least one of instantiate or execute the machine readable instructions to compare a road wheel angle request to a threshold, in response to determining that the road wheel angle request is greater than the threshold determine a first steering wheel angle corresponding to the road wheel angle request from a first set of data that associates road wheel angle-to-steering wheel angle, and calculate a first steering pinion angle based on the first steering wheel angle and a first steering ratio obtained from the first set of data, in response to determining that the road wheel angle request is less than the threshold determine a second steering wheel angle corresponding to the road wheel angle from a second set of data that associates road wheel angle-to-steering wheel angle, wherein the second set of data is asymmetric relative to the first set of data, and calculate a second steering pinion angle based on the second steering wheel angle and a second steering ratio obtained from the second set of data.
Example 10 includes the apparatus of example 9, wherein the programmable circuitry is to determine the first steering pinion angle based on a first steering angle offset.
Example 11 includes the apparatus of examples 10 or 11, wherein the programmable circuitry is to determine the first steering angle offset based on a difference between the first steering wheel angle and an actual steering wheel angle of a current position of a steering wheel.
Example 12 includes the apparatus of any one of examples 9-11, further including programmable circuitry to at least one of instantiate or execute the machine readable instructions to cause a steering gear to move to the first steering pinion angle.
Example 13 includes the apparatus of any one of examples 9-12, wherein the programmable circuitry is to determine the second steering pinion angle based on a second steering angle offset.
Example 14 includes the apparatus of any one of examples 9-13, wherein the programmable circuitry is to determine the second steering angle offset based on a difference between the second steering wheel angle and an actual steering wheel angle of a current position of a steering wheel.
Example 15 includes the apparatus of any one of examples 9-14, further including programmable circuitry to at least one of instantiate or execute the machine readable instructions to cause a steering gear to move to the second steering pinion angle.
Example 16 includes at least one non-transitory machine-readable medium comprising machine-readable instructions to cause at least one processor circuit to at least compare a road wheel angle request to a threshold, in response to determining that the road wheel angle request is greater than the threshold determine a first steering wheel angle corresponding to the road wheel angle request from a first set of data that associates road wheel angle-to-steering wheel angle, and calculate a first steering pinion angle based on the first steering wheel angle and a first steering ratio obtained from the first set of data, in response to determining that the road wheel angle request is less than the threshold determine a second steering wheel angle corresponding to the road wheel angle from a second set of data that associates road wheel angle-to-steering wheel angle, wherein the second set of data is asymmetric relative to the first set of data, and calculate a second steering pinion angle based on the second steering wheel angle and a second steering ratio obtained from the second set of data.
Example 17 includes the at least one non-transitory machine-readable medium of example 16, wherein the machine-readable instructions are to cause one or more of the at least one processor circuit to determine the first steering pinion angle based on a first steering angle offset.
Example 18 includes the at least one non-transitory machine-readable medium of examples 17 or 18, wherein the machine-readable instructions are to cause one or more of the at least one processor circuit to determine the first steering angle offset based on a difference between the first steering wheel angle and an actual steering wheel angle of a current position of a steering wheel.
Example 19 includes the at least one non-transitory machine-readable medium of any one of examples 16-18, wherein the machine-readable instructions are to cause one or more of the at least one processor circuit to determine the second steering pinion angle based on a second steering angle offset provided by a difference between the second steering wheel angle and an actual steering wheel angle of a current position of a steering wheel.
Example 20 includes the at least one non-transitory machine-readable medium of any one of examples 16-19, wherein the machine-readable instructions are to cause one or more of the at least one processor circuit to cause a steering gear to move to the first steering pinion angle in response to determining that the road wheel angle request is greater than the threshold or the second steering pinion angle in response to determining that the road wheel angle request is less than the threshold.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a steering linkage assembly including a drag link having a first end and a second end opposite the first end, the drag link configured to couple to a hydraulic power assist system and an electric power assist system, the hydraulic power assist system to couple to a vehicle frame and the first end of the drag link via a first pitman arm, the electric power assist system to couple to the vehicle frame and the first end of the drag link via a second pitman arm, the first pitman arm differently shaped than the second pitman arm to enable the first pitman arm and the second pitman to have a common pitman to hardpoint connection with the drag link of the steering linkage assembly.

2. The apparatus of claim 1, wherein the steering linkage assembly provides an asymmetric number of steering wheel revolutions between straight ahead and full lock left and full lock right.

3. The apparatus of claim 1, wherein the drag link has a same length when the hydraulic power assist system or the electric power assist system is coupled to the vehicle frame.

4. The apparatus of claim 1, wherein the steering linkage assembly further includes:
a tie rod end, the tie rod end to couple to the second end of the drag link; and
an adjustment sleeve to couple the drag link and the drag link end.

5. The apparatus of claim 4, wherein the drag link, the drag link end, and the adjustment sleeve have same respective lengths when the hydraulic power assist system or the electric power assist system is coupled to the vehicle frame.

6. The apparatus of claim 1, wherein the first pitman arm is angled inboard relative to the vehicle frame to couple to the hydraulic power assist system and the drag link.

7. The apparatus of claim 1, wherein the second pitman arm is angled outboard relative to the vehicle frame to couple the electric power assist system and the drag link.

8. The apparatus of claim 1, wherein a first opening of the first pitman arm that couples to the hydraulic power assist system is positioned at a first distance relative to a longitudinal axis of the frame when the first pitman arm is coupled to the vehicle, a second opening of the second pitman arm that couples to the electric power assist system is positioned at a second distance relative to the longitudinal axis of the frame when the second pitman arm is coupled to the vehicle, wherein the first distance is greater than the second distance..

9. An apparatus comprising:
interface circuitry;
machine readable instructions; and
programmable circuitry to at least one of instantiate or execute the machine readable instructions to:
compare a road wheel angle request to a threshold;
in response to determining that the road wheel angle request is greater than the threshold:
determine a first steering wheel angle corresponding to the road wheel angle request from a first set of data that associates road wheel angle-to-steering wheel angle; and
calculate a first steering pinion angle based on the first steering wheel angle and a first steering ratio obtained from the first set of data;
in response to determining that the road wheel angle request is less than the threshold:
determine a second steering wheel angle corresponding to the road wheel angle from a second set of data that associates road wheel angle-to-steering wheel angle, wherein the second set of data is asymmetric relative to the first set of data; and
calculate a second steering pinion angle based on the second steering wheel angle and a second steering ratio obtained from the second set of data.

10. The apparatus of claim 9, wherein the programmable circuitry is to determine the first steering pinion angle based on a first steering angle offset.

11. The apparatus of claim 10, wherein the programmable circuitry is to determine the first steering angle offset based on a difference between the first steering wheel angle and an actual steering wheel angle of a current position of a steering wheel.

12. The apparatus of claim 9, further including programmable circuitry to at least one of instantiate or execute the machine readable instructions to cause a steering gear to move to the first steering pinion angle.

13. The apparatus of claim 12, wherein the programmable circuitry is to determine the second steering pinion angle based on a second steering angle offset.

14. The apparatus of claim 13, wherein the programmable circuitry is to determine the second steering angle offset based on a difference between the second steering wheel angle and an actual steering wheel angle of a current position of a steering wheel.

15. The apparatus of claim 9, further including programmable circuitry to at least one of instantiate or execute the machine readable instructions to cause a steering gear to move to the second steering pinion angle.

16. At least one non-transitory machine-readable medium comprising machine-readable instructions to cause at least one processor circuit to at least:
compare a road wheel angle request to a threshold;
in response to determining that the road wheel angle request is greater than the threshold:
determine a first steering wheel angle corresponding to the road wheel angle request from a first set of data that associates road wheel angle-to-steering wheel angle; and
calculate a first steering pinion angle based on the first steering wheel angle and a first steering ratio obtained from the first set of data;
in response to determining that the road wheel angle request is less than the threshold:
determine a second steering wheel angle corresponding to the road wheel angle from a second set of data that associates road wheel angle-to-steering wheel angle, wherein the second set of data is asymmetric relative to the first set of data; and
calculate a second steering pinion angle based on the second steering wheel angle and a second steering ratio obtained from the second set of data.

17. The at least one non-transitory machine-readable medium of claim 16, wherein the machine-readable instructions are to cause one or more of the at least one processor circuit to determine the first steering pinion angle based on a first steering angle offset.

18. The at least one non-transitory machine-readable medium of claim 17, wherein the machine-readable instructions are to cause one or more of the at least one processor circuit to determine the first steering angle offset based on a difference between the first steering wheel angle and an actual steering wheel angle of a current position of a steering wheel.

19. The at least one non-transitory machine-readable medium of claim 17, wherein the machine-readable instructions are to cause one or more of the at least one processor circuit to determine the second steering pinion angle based on a second steering angle offset provided by a difference between the second steering wheel angle and an actual steering wheel angle of a current position of a steering wheel.

20. The at least one non-transitory machine-readable medium of claim 16, wherein the machine-readable instructions are to cause one or more of the at least one processor circuit to cause a steering gear to move to the first steering pinion angle in response to determining that the road wheel angle request is greater than the threshold or the second steering pinion angle in response to determining that the road wheel angle request is less than the threshold.
